(19) United States
(12) Patent Application Publication
(10) Pub. No.: US 2013/0237312 A1
(43) Pub. Date: Sep. 12, 2013

(54) GAMING SYSTEM, CONTROLLER AND METHOD

(71) Applicant: PALTRONICS, INC., Crystal Lake, IL (US)

(72) Inventor: Angelo PALMISANO, Crystal Lake, IL (US)

(73) Assignee: PALTRONICS, INC., Crystal Lake, IL (US)

(21) Appl. No.: 13/649,104

(22) Filed: Oct. 10, 2012

Related U.S. Application Data
(60) Provisional application No. 61/546,034, filed on Oct. 11, 2011.

(51) Int. Cl. G07F 17/32

(52) U.S. Cl. CPC G07F 17/3258; G07F 17/3244
USPC 463/26; 463/25

(57) ABSTRACT

A method for awarding prizes comprises accessing a player account responsive to a player inputting a player identifier at a gaming device. The player account is capable of storing identification information associated with one or more other players nominated by the player. The method further involves setting a prize parameter for a triggerable game event that the player is eligible to be awarded based, at least in part, on a play parameter for the associated one or more other players.

### CROSS REFERENCE TO RELATED APPLICATIONS

This application claims priority from provisional application Ser. No. 61/546,034, filed Oct. 11, 2011, the content of which is incorporated herein in its entirety.

### FIELD OF THE INVENTION

The present invention relates to a gaming system, a controller and method for awarding prizes.

### BACKGROUND

Many modern-day gaming venues implement networked gaming systems whereby multiple gaming devices are able to communicate with a central controller, for example, to allow the devices to participate in a linked game event, provide remote monitoring/control of the game devices, etc.

One common form of linked game event is a jackpot prize event whereby players of gaming devices within the network are eligible to win bonus prizes or large jackpot prizes. For example, in a linked event where jackpot prizes are awarded, a portion of turnover on each gaming device will typically be forwarded to a jackpot controller as a contribution (i.e. so as to fund a prize pool from which the jackpot prizes are awarded). This technique can be extended to a so-called wide area jackpot where gaming devices operating in different venues contribute to a single jackpot pool.

While such linked prize awarding techniques provide an opportunity for players to win large jackpot prizes, the need exists for alternative gaming systems in order to maintain or increase player enjoyment. It would also be advantageous if there was provided a gaming system which enhanced social interaction between players.

### SUMMARY OF THE INVENTIONS

In accordance with a first aspect of the present invention there is provided a method for awarding prizes, the method comprising:
accessing player account data for a player responsive to inputting of a player identifier at a gaming device, the player account data comprising identification information associated with one or more other players nominated by the player; and
setting a prize parameter for a triggerable game event that the player is eligible to be awarded based, at least in part, on a play parameter for the associated one or more other players.

In an embodiment the prize parameter comprises a value of a prize awarded in the game event.

In an embodiment the prize parameter comprises a range of prize values for one or more prizes awarded in the game event.

In an embodiment a plurality of distinct prize ranges are settable for the game event.

In an embodiment the game event is a bonus game in which one or more bonus or jackpot prizes may be awarded.

In an embodiment the method further comprises triggering the bonus game independently of an outcome of a main game.

In an embodiment the method comprises the further step of determining whether the one or more associated players are concurrently playing a respective gaming device.

In an embodiment the play parameter comprises a number of the associated players determined to be concurrently playing a respective gaming device.

In an embodiment the method further comprises determining an amount wagered by the one or more players concurrently playing a gaming device.

In an embodiment the play parameter additionally or alternatively comprises the determined amount.

In an embodiment the method further comprises distributing at least a portion of a prize awarded in the game event to one or more of the associated players.

In an embodiment the portion distributed to each of the one or more associated players is determined, at least in part, from an amount wagered by the respective players at or around the time the game event was triggered.

In an embodiment the method further comprises allowing the player to specify the portion of the prize that is distributed to the one or more associated players.

In an embodiment the method further comprises allowing the player to communicate with the one or more associated players by way of a communications interface provided by the gaming device.

In an embodiment the method further comprises displaying the communications interface in association with the game.

In an embodiment the player account is a social networking accounting implemented independently of the gaming system.

In an embodiment the method further comprises requiring the player to place a wager which is supplementary to a wager placed on the main game in order to qualify for the game event.

In an embodiment the method further comprises allowing one or more of the associated players to participate in the game event.

In accordance with a second aspect of the present invention there is provided a game controller, the controller comprising:
a player account module operable to access player account data for a player responsive to a player identifier being input at a gaming device, the player account data comprising identification information associated with one or more other players nominated by the player; and
a prize setting module operable to set a prize parameter for a triggerable game event that the player is eligible to be awarded based, at least in part, on a play parameter for the associated one or more other players.

In an embodiment the prize parameter comprises a value of a prize awardable in the game event.

In an embodiment the prize parameter comprises a range of prize values for one or more prizes awardable in the game event.

In an embodiment a plurality of distinct prize ranges are settable for the game event.

In an embodiment the game event is a bonus game in which one or more bonus or jackpot prizes may be awarded.

In an embodiment the bonus game is arranged to be triggered independently of an outcome of a main game.

In an embodiment the player account module is further configured to determine whether the one or more associated players are concurrently playing a respective gaming device and wherein the play parameter comprises a number of the other players determined to be concurrently playing a gaming device.

In an embodiment the play parameter additionally or alternatively comprises an amount wagered by one or more of the associated players determined to be concurrently playing a gaming device.

In an embodiment the player account module in configured to distribute at least a portion of a prize awarded in the game event to one or more of the associated players in dependence on either a player or device determination.

In an embodiment the gaming device is a video lottery terminal.

In an embodiment the game controller is implemented by a central control system operable to control game play of the video lottery terminal.

In accordance with at third aspect of the present invention there is provided a jackpot controller for awarding jackpot prizes in a networked gaming environment, the jackpot controller comprising:
a player account module operable to access player account data associated with a player, the player account data comprising identification information associated with one or more other players nominated by the player; and
a prize setting module operable to evaluate the player account data and to set a prize parameter for a jackpot prize based, at least in part, on a play parameter for the associated one or more other players; and
an award module for awarding the jackpot prize to the player responsive to the detection of a jackpot trigger.

In accordance with a fourth aspect there is provided a method for communicating between gaming devices operating in a gaming system, the method comprising:
accessing player account data for a social network account of a player responsive to inputting of a player identifier at a gaming device, the player account data comprising identification information associated with one or more other players nominated by the player; and
providing a communications interface on the gaming device which allows the player to communicate with the associated players.

In an embodiment the method comprises the further step of allowing the player to invite one or more of the associated players to participate in a networked gaming event, utilising the communications interface.

In an embodiment the method comprises the further step of allowing the player to search for players of the gaming system not associated with their player account to communicate with via the communications interface.

In an embodiment the social network account is maintained independently of the gaming system.

In an embodiment the communications interface is displayed in association with one or more games implemented by the gaming device.

In accordance with a fifth embodiment there is provided a computer program comprising at least one instruction which when implemented by a computer system is arranged to cause the system to implement the method as described in accordance with the aforementioned first and third aspects.

Embodiments of the present invention may be applied to any suitable type of gaming system or platform. It can apply to any gaming apparatus that are capable of being linked together, e.g. via a network such as an intranet, and/or to gaming systems provided through computing or other electronic devices, e.g. personal computers, PDAs, mobile telephones, digital televisions, and the like, e.g. over the Internet or other communications networks.

Embodiments may be applied to gaming apparatus that play any suitable game, e.g. slot-machine type games, poker, keno, blackjack, bingo, roulette, pachinko, or the like.

### BRIEF DESCRIPTION OF DRAWINGS

An exemplary embodiment of the invention will now be described with reference to the accompanying drawings in which:

FIG. 1 is a block diagram of a gaming machine for use with an embodiment of the present invention;

FIG. 2 is a block diagram of a gaming network in accordance with an embodiment;

FIG. 3 is a block diagram of the prize controller shown in FIG. 2;

FIG. 4 is a process flow for awarding prizes in accordance with an embodiment.

### DETAILED DESCRIPTION

Embodiments relate to a gaming system in which a plurality of gaming devices communicate with a central control system over a network, such as a wide area network or local area network.

The gaming system comprises a prize controller which implements a player account module operable to access player account data for a selected player. The player account data comprises identification information associated with one or more other players (e.g. nominated by the player). A prize setting module implemented by the prize controller sets a prize parameter for a game event to be awarded to the gaming device based, at least in part, on a play parameter for the associated one or more other players.

General Construction of a Gaming Terminal

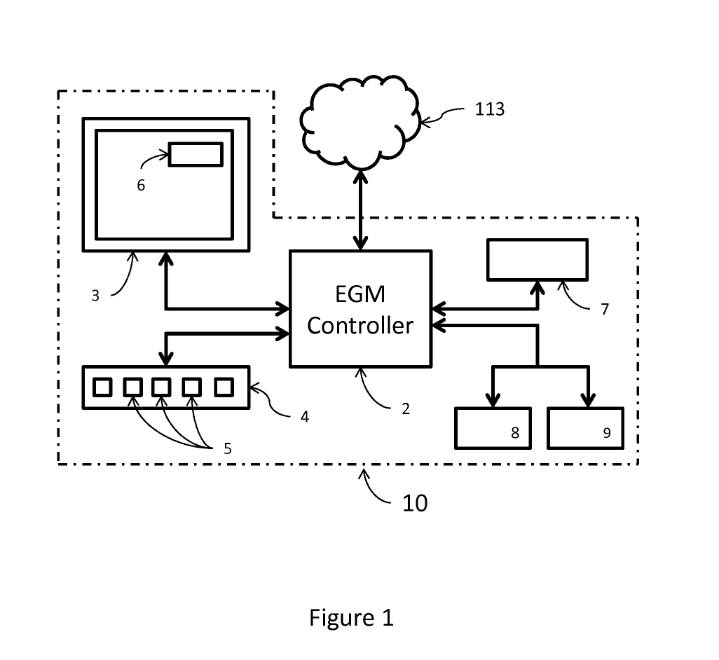

Referring to FIG. 1 there is shown an exemplary gaming device 10 for use with a gaming network 100 of the type typically used in casinos. The gaming device 10 is in the form of an electronic gaming machine which includes various standard components, such as a game controller 2, for controlling the operation of the device and the games which run on it. The device 10 comprises one or more displays 3, such as plasma screen displays, for displaying game screens. A player input means 4 is provided for enabling a user to interact with the device 10 and may include, for example, a bank of buttons 5 located in a mid-trim of the device 10. The buttons 5 may alternatively or additionally be provided as part of the display 3, in a touch-screen type manner. The device 10 also includes a player tracking module 6 having a reading device (e.g. a card scanner for reading a loyalty card or other form of portable storage medium capable of being read by the card scanner) which communicates with a player tracking subsystem implemented by the central control system 102 for providing player tracking and loyalty type functions, as is well understood in the art. The device 10 also implements a note acceptor 7 (also commonly referred to as a bill collector) adapted to accept bank notes as well as cashless instruments, such as paper tickets or coupons, for inputting credits. The note acceptor 7 is additionally configured to dispense notes and tickets/coupons, for paying out winnings. A coin input chute 8 and output tray 9 are provided as an alternative means for inputting credits and dispensing cash winnings, respectively. An in-machine meter (not shown) is also provided to cooperate with the central control system 102 for providing information regarding game plays, amounts of wagers, payoffs, etc. Additional hardware may be included as part of the device 10, or hardware may be omitted as required by the specific implementation.

General System Configuration

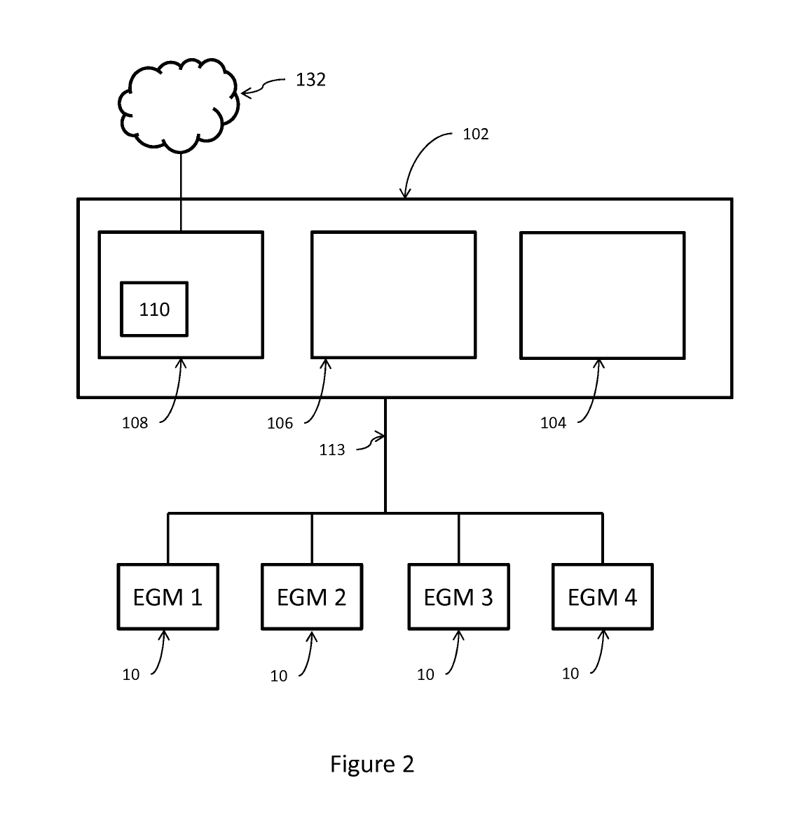

As alluded to above, and with additional reference to FIG. 2, a plurality of gaming devices 10 may be located on a casino floor (or indeed located in different venues, depending on the network configuration) and be configured to communicate with one or more central control systems 102 by a networked environment, e.g. via wide area network 113. According to the presently described embodiment, the central control system 102 implements three main subsystems as will now be described.

A management and accounting subsystem 104 provides management and accounting functions, also sometimes called auditing functions. Typically, these functions gather and/or report coin-in and coin-out operations, door openings (e.g., when a gaming device is serviced), service cycles in general, ticket replacements, and the like. This activity generally is linked to the game being played on the gaming device and/or the gaming device itself.

A second subsystem system, player tracking subsystem 106, provides player tracking functions. More specifically, such systems link players of gaming devices to particular activities undertaken by the players. The information typically tracked for each player includes, for example, the session of game play (e.g., date, time, location, type of machine, type of game, etc.) as well as the individual's profile (e.g., name, address, and/or other identifying information). The player tracking subsystem interfaces with the gaming devices via the player tracking module 6.

A bonusing subsystem 108 provides enhancements which may or may not be related to the base/main game playable on the gaming devices. Such enhancements may relate, for example, to bonusing, progressive games, mystery, secondary games, random rewards (e.g., as disclosed in U.S. Pat. No. 6,626,758, the contents of which are incorporated herein by reference), or any suitable bonus program whereby eligible players may be awarded a bonus prize. The bonusing subsystem 108 is also configured to interface with the gaming devices via the player tracking module 6.

Further Detail of the Prize Controller

As previously mentioned, particular embodiments relate to techniques for setting a prize parameter for a triggerable game event that a player of a networked gaming device is eligible to be awarded. The prize parameter is determined, at least in part, on a play parameter for one or more players linked or otherwise associated with a social network account of the player. According to the illustrated embodiment, the social network account is a “Facebook” account which will be appreciated is implemented and maintained independently of the gaming system. The way in which the presently described gaming system interfaces with the social network system to retrieve the player account data and sets the prize parameter will become apparent from subsequent paragraphs. It will be understood that the social network account described herein is not in any way limited to being a Facebook account and could be any social network account including, for example, a Twitter account, Google account, or any suitable social networking account. Furthermore, in one particular embodiment, the social networking account may be implemented and maintained by the gaming system (i.e. as a proprietary service for players of the gaming system).

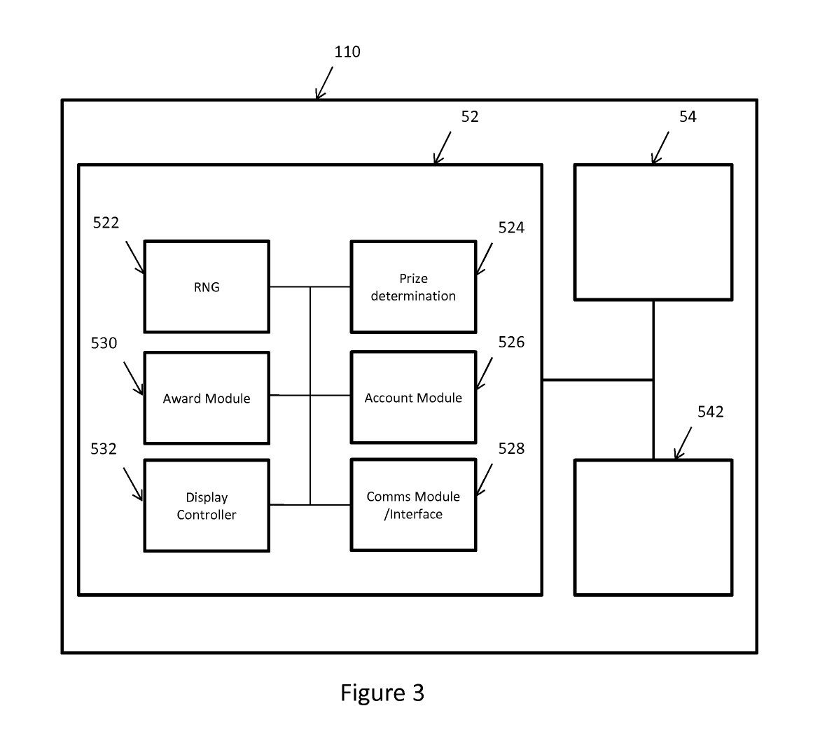

To carry out such functionality, the gaming system 100 comprises a prize controller 110, as shown in more detail in FIG. 3. According to the illustrated embodiment, the prize controller 110 is incorporated into the bonusing subsystem 108 of the central control system 102, although it will be understood that the prize controller 110 could be incorporated into other network elements, such as the player tracking system etc., depending on the desired implementation. For simplicity, only those modules (which may be implemented in software, hardware or a combination of the two) needed to carry out embodiments of the invention are illustrated.

In more detail, the prize controller 110 includes a processor 52 which is arranged to carry out a number of functions associated with the setting of prize parameters and awarding of bonus or jackpot prizes. It will be apparent that the processor 52 implements a number of modules, namely a random number generator 522, a prize determination module 524, account module 526, communications module 528, award module 530 and display controller module 532 based on program code stored in memory 54.

The memory 54 is also arranged to provide a database 542 which stores player information relevant to the play parameter for associated players. The player information may, for example, be provided by the management subsystem 104 and/or player tracking subsystem 106 upon request or on a periodic basis.

According to the illustrated embodiment, the game event is a randomly rewarded prize awarded in a variant of a linked bonus game entitled “random rewards” which is described in the co-pending U.S. application Ser. No. 11/979,418 (Publication No. 2009/0117999) by the same applicant, the contents of which are incorporated herein by reference.

In brief, the random rewards bonus game is a mystery-like variant that behaves much like a standard mystery behaves, except that random rewards generates additional excitement by randomly rewarding patrons with smaller, more frequent bonuses awards while the random rewards top award (hereafter “the jackpot prize”) grows. With each new game played on an eligible device, the player typically is shown the jackpot prize amount they could win if their gaming device is randomly selected to pay out its random rewards amount. Any linked gaming device may randomly initiate a random rewards trigger event (e.g. based on a “coin-in” event associated with a player wager) which results in one of the eligible devices on the link being randomly selected to reward its random rewards amount to the device. The random rewards trigger events are counted and, once this count reaches a randomly selected threshold, an eligible gaming device on the link is randomly selected to receive the random rewards jackpot prize.

According to the particular embodiment described herein, the random rewards bonus game implements different prize tiers having distinct prize ranges. For example, the random rewards bonus game may implement three distinct prize tiers as follows:
Silver—random rewards amounts between $5 and $10 with a jackpot prize value starting at $50
Gold—random rewards amounts between $20 and $30 with a jackpot prize value starting at $100
Platinum—random rewards amounts between $40 and $60 with a jackpot prize value starting at $1000

The particular prize tier that a player is eligible for depends, at least in part, on a play parameter for linked player associations. In the illustrated embodiment, the play parameter relates to the number of “friends” associated with the player's account that are determined to be concurrently playing a respective gaming device 10 in the network 113 and who have accepted an express invitation by the player to participate in the random rewards bonus game.

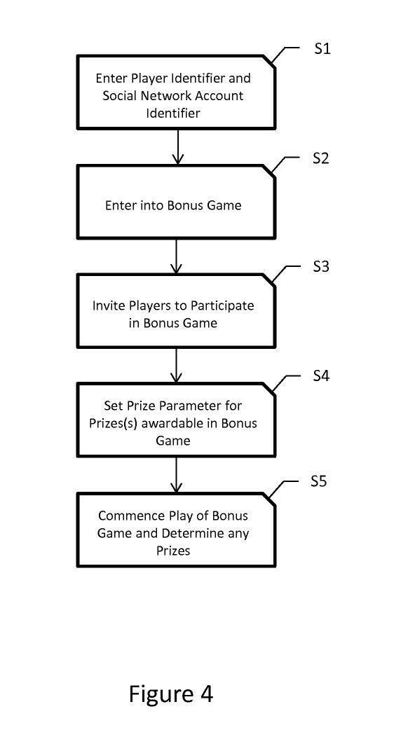

Implementation of a specific embodiment will now be described in more detail with reference to the flow diagram 200 of FIG. 4. In an initial step S1 a player enters a player identifier at a gaming device. This may be achieved, for example, by inserting a player loyalty card on which is encoded the player identifier, or by entering in a login name and pincode by way of the buttons 5 provided on the gaming device 110. The player is then presented with a graphic user interface (e.g. on the video display in association with the main game screen) generated by the communications module 528 which allows the player to enter a social network identifier and password, if applicable, for a particular social networking service (e.g. Facebook, Google, Twitter, etc.). Upon entering the social network identifier and password, a web socket implemented by the communications module 528 exposes the gaming system 100 to the player's social network account for use in generating the bonus game screen of the user interface as described in more detail at step S2. The player identifier and social network identifier are then forwarded by the communications module 526 to the player tracking subsystem 106.

In response to the player inputting their social network identifier, the player then indicates whether they would like to enter into a random rewards bonus game by selecting a button on the graphic user interface (step S2). If the player opts to enter the game they are then presented with a bonus game screen which allows the player to see which of their friends are concurrently playing a gaming device in the network and to send messages to those friends inviting them to participate in the event (step S3). This data may be determined in response to a query sent by the account module 526 to the player tracking subsystem 106 (which, as will be understood by persons skilled in the art, stores the necessary player information to answer this query). The account module 526 may also request wager related data from the management and account subsystem 104, for those players that are determined to be concurrently playing the respective gaming devices 10. The wager related data may comprise, for example, current or accumulated wager amounts. The player may also use the bonus game screen to search for players operating gaming devices in the network that are not currently linked to their account (i.e. are not currently tagged as “friends”) and invite them to participate in the bonus game, again using the bonus game screen. The bonus game screen may also be used to accept invitation requests from other players (i.e. for participating in other bonus games or game events).

At step S4 the data received from the player tracking subsystem 106 and management account subsystem 104 is provided to the prize determination module 524 for use in setting a prize parameter for the random rewards bonus game. As mentioned above, the prize parameter for the presently described embodiment relates to a tier level for prizes awarded in the game. Each of the levels may, for example, be associated with a particular number or threshold value of linked players participating in the game. For example, the silver tier may be selected upon determining that between 0 and 5 associated players are participating in the game, the gold level between 6 and 10 associated players and the platinum level for greater than 10 associated players.

Once the tier level has been set by the prize determination module 524, at step S5 play of the random rewards game commences with prizes being randomly awarded by the award module 530 within the selected tier level (i.e. as per the award determination techniques described in the afore-referenced random rewards patent application US2009/0117999).

It will be understood that player association parameters other than those described above may alternatively or additionally apply for setting the prize parameter (in the presently described embodiment being in the form of the particular tier level, although it will be understood that the following alternative player association parameters may apply for any suitable prize parameter setting). For example, the amount wagered by each of the players participating in the game may influence the tier level selection. This may be based on either a current accumulated amount or an accumulated amount over some predefined period of time. In one particular embodiment, the tier level selection may be dynamically adjusted during play of the rewards game either in dependence on the wager amount or some other performance parameter. For example, the tier may be increased where the combined wager value passes some threshold value or decreased where the combined wager value falls below some threshold value. In another particular embodiment, players may be able to join or leave the game event after play of the bonus game has commenced such that the tier level is dynamically adjusted based on the number of players currently participating in the game event. Another parameter that could additionally or alternatively influence the tier selection could be the number of associations each of the associated players have (i.e. second degree associations). Yet another parameter that could influence the selection may be the current time and/or date, such that during slow periods the tier selection may be improved to encourage game play.

In one embodiment the bonus screen displayed on the gaming device display 3 may provide a messaging interface for communicating with their friends. Again, this may be readily facilitated via the web socket and may replicate the Facebook interface. As mentioned in preceding paragraphs, the interface may also allow the player to invite and accept player invitations for bonus games and associate new players with their account (e.g. by accepting them as friends). In one particular embodiment the interface provides video messaging capabilities.

In one particular embodiment, a supplementary prize or a portion of the prize awarded to the player in the game event may be distributed to or shared with the other players participating in the event. For example, with the random rewards implementation, the jackpot prize award may be shared between each of the participating players. The distribution may be determined either by the player (e.g. using the interface described above) or automatically determined by the award module 526 based on predefined distribution rules stored in memory 54. For example, according to the automatically determined implementation, the distribution rules may tie the distribution amount for each associated player to the amount wagered by that player at or around the time the event was triggered. Other distribution scenarios include: equally sharing the jackpot prize, distributing the prize based on weighted performance, distributing the prize based on tenure in the event, distributing the prize in a pyramidal type way whereby the distribution depends on a “who invited who” social structure.

It will be appreciated that the game event and corresponding prize parameter may vary depending on the desired implementation and should not be seen as being limited to the particular bonus game embodiment described herein. For example, the game event could relate to a prize or game outcome awarded in association with a main game played on a respective gaming device (e.g. a feature game, a series of free spins, an enhanced prize within the main game, etc.), or could relate to any form of jackpot or bonus prize which is triggered either in dependence of an outcome of a game played on a linked gaming device (e.g. based on a symbol driven trigger) or independently of any in-game triggers (such as a typical “mystery” jackpot as is well understood by persons skilled in the art). Equally, the prize could be a non-monitory prize such as a venue sponsored prize or a marketing driven promotional prize (e.g. meal voucher, complimentary drink, etc.). In this regard, the prize parameter could, for example, relate to a value or type of awarded prize. It will be appreciated that according to a particular embodiment, the player may be required to place a supplementary or side wager (i.e. in addition to a wager placed on a main game) in order to be eligible for/accept a request to participate in the triggered game event. In one particular embodiment, the system may implement different game events for different social networking groups (e.g. Facebook account holders may participate in form of game event having a particular prize structure, while Twitter account holders may participate in another event having a different prize structure).

In an alternative embodiment to that described above the system may be implemented over a distributed architecture where some of the individual gaming device modules are implemented remotely. For example, in one particular form, the gaming system may implement a video lottery terminal architecture whereby a central control server located remotely of the gaming devices comprises a controller which controls some or all of the game play functionality (i.e. such that the gaming devices essentially operates as a remote client terminals arranged to provide audible and/or visual gaming information to a player and allow player interaction with the central control computer). A plurality of client terminals may be in communication with the central control server over a communications network such as a local area network and/or a wide area network. In an alternative embodiment, the game play functionality may be implemented by both the gaming device and the central control server such that they collectively provide a game controller. Furthermore, as mentioned in preceding paragraphs, embodiments may be implemented as an online game which may be tied to a particular casino rewards program. For example, according to such an embodiment, points may be earned based on amount of time the player is wagering, the amount wagered, the number of associations with other members of the specific social network, the amount of losses the social network group has collectively lost or won, etc.

It will be appreciated that for the video lottery terminal architecture outlined above, the central control server has access to associated memory and storage devices. The central control server also has access to computer executable code for instructing the central control server to run the gaming algorithm that performs embodiments of the inventive method. In one embodiment the computer executable code is in the form of software and associated data, which are stored upon a computer-readable medium in the form of one or more compact disks. Alternative embodiments make use of other forms of digital storage media, such as Digital Versatile Discs (DVD's), hard drives, flash memory, Erasable Programmable Read-Only Memory EPROM, and the like. Alternatively, the software and its associated data may be stored as one or more downloadable or remotely executable files that are accessible via a computer communications network such as the Internet.

It will also be appreciated that the player account could be any account capable of storing player/friend associations and being accessible by the central control system 102. In one particular embodiment the gaming system may not need to access an external social networking site and instead provide players with the capability to message and store player associations with a proprietary account (e.g. as maintained by the player tracking system).

Further aspects of the method will be apparent from the above description of the gaming system. Persons skilled in the art will also appreciate that the method could be embodied in program code. The program code could be supplied in a number of ways, for example on a computer readable medium, such as a disc or a memory (for example, that could replace part of memory) or as a data signal (for example, by downloading it from a server).

It is to be understood that various alterations, additions and/or modifications may be made to the parts previously described without departing from the ambit of the present invention, and that, in the light of the above teachings, the present invention may be implemented in software, firmware and/or hardware in a variety of manners as would be understood by a person skilled in the art.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for awarding prizes, the method comprising:
accessing player account data for a player responsive to inputting of a player identifier at a gaming device, the player account data comprising identification information associated with one or more other players nominated by the player; and
setting a prize parameter for a triggerable game event that the player is eligible to be awarded based, at least in part, on a play parameter for the associated one or more other players.

2. A method in accordance with claim 1, wherein the prize parameter comprises a value of a prize awarded as part of the game event

3. A method in accordance with claim 1, wherein the prize parameter comprises a range of prize values for one or more prizes awarded in the game event.

4. A method in accordance with claim 3, wherein a plurality of distinct prize ranges are settable for the game event.

5. A method according to claim 1, wherein the game event is a bonus game in which one or more bonus or jackpot prizes may be awarded.

6. A method according to claim 5, further comprising triggering the bonus game independently of an outcome of a main game.

7. A method according to claim 1, comprising the further step of determining whether the one or more associated players are concurrently playing a respective gaming device.

8. A method according to claim 7, wherein the play parameter comprises a number of the associated players determined to be concurrently playing a respective gaming device.

9. A method according to claim 7, further comprising determining an amount wagered by the one or more players concurrently playing a gaming device.

10. A method according to claim 9, wherein the play parameter additionally or alternatively comprises the determined amount.

11. A method according to claim 1, further comprising distributing at least a portion of a prize awarded as part of the game event to one or more of the associated players.

12. A method according to claim 11, wherein the portion distributed to each of the one or more associated players is determined, at least in part, from an amount wagered by the respective players at or around the time the game event was triggered.

13. A method according to claim 11, further comprising allowing the player to specify the portion of the prize that is distributed to the one or more associated players.

14. A method according to claim 1, further comprising allowing the player to communicate with the one or more associated players by way of a communications interface provided by the gaming device.

15. A method according to claim 14, further comprising displaying the communications interface in association with the game.

16. A method according to claim 1, wherein the player account is a social network account implemented independently of the gaming system.

17. A method according to claim 6, further comprising requiring the player to place a wager which is supplementary to a wager placed on the main game in order to qualify for the game event.

18. A method according to claim 1, further comprising allowing one or more of the associated players to participate in the game event.

19. A game controller, the controller comprising:
a player account module operable to access player account data for a player responsive to a player identifier being input at a gaming device, the player account data comprising identification information associated with one or more other players nominated by the player; and
a prize setting module operable to set a prize parameter for a triggerable game event that the player is eligible to be awarded based, at least in part, on a play parameter for the associated one or more other players.

20. A game controller in accordance with claim 19, wherein the prize parameter comprises a value of a prize awardable as part of the game event.

21. A game controller in accordance with claim 19, wherein the prize parameter comprises a range of prize values for one or more prizes awardable in the game event.

22. A game controller in accordance with claim 21, wherein a plurality of distinct prize ranges are settable for the game event.

23. A game controller according to claim 19, wherein the game event is a bonus game in which one or more bonus or jackpot prizes may be awarded.

24. A game controller according to claim 23, wherein the bonus game is arranged to be triggered independently of an outcome of a main game.

25. A game controller according to claim 19, wherein the player account module is further configured to determine whether the one or more associated players are concurrently playing a respective gaming device and wherein the play parameter comprises a number of the other players determined to be concurrently playing a gaming device.

26. A game controller according to claim 25, wherein the play parameter additionally or alternatively comprises an amount wagered by one or more of the associated players determined to be concurrently playing a gaming device.

27. A game controller according to claim 19, wherein the player account module in configured to distribute at least a portion of a prize awarded in the game event to one or more of the associated players in dependence on either a player or device determination.

28. A game controller according to claim 19, wherein the gaming device is a video lottery terminal.

29. A game controller according to claim 28, wherein the game controller is implemented by a central control system operable to control game play of the video lottery terminal.

30-31. (canceled)

32. A method for awarding prizes, the method comprising:
allowing a player of a gaming device to invite one or more other players operating other respective gaming devices to participate in a shared game event using a gaming interface provided on the player's gaming device; and
setting a prize parameter for a triggerable event in the shared game based, at least in part, on a play parameter for the associated one or more other players.

33. A method according to claim 32, wherein in order to participate in the shared game event a player must place a wager which is supplementary to a wager placed on a main game playable on the respective gaming device.

34. A computer program comprising at least one instruction which when implemented by a computer system is arranged to cause the system to implement the method according to claim 1.

35. (canceled)

36. A computer program comprising at least one instruction which when implemented by a computer system is arranged to cause the system to implement the method according to claim 32.

37. A computer readable medium storing a computer program product as claimed in claim 34.
